(19) United States
(12) Patent Application Publication
(10) Pub. No.: US 2026/0351644 A1
(43) Pub. Date: Nov. 5, 2026

(54) ELECTROCHEMICAL CELL, ELECTROCHEMICAL CELL DEVICE, MODULE, AND MODULE HOUSING DEVICE

(71) Applicant: KYOCERA Corporation, Kyoto-shi, Kyoto (JP)

(72) Inventors: Makoto KOI, Kirishima-shi, Kagoshima (JP); Kazunari MIYAZAKI, Kirishima-shi, Kagoshima (JP)

(21) Appl. No.: 19/487,306

(22) PCT Filed: May 28, 2024
(86) PCT No.: PCT/JP2024/019504

§ 371 Date: Nov. 24, 2025

(30) Foreign Application Priority Data
May 31, 2023 (JP) 2023-090266

(51) Int. Cl. H01M 8/1246; H01M 4/86; H01M 4/90; H01M 8/12; H01M 8/2475

(52) U.S. Cl. CPC H01M 8/1246; H01M 4/8642; H01M 4/9041; H01M 8/2475; H01M 2008/1293

(57) ABSTRACT

An electrochemical cell includes a first electrode layer, a second electrode layer, and a solid electrolyte layer. The solid electrolyte layer is located between the first electrode layer and the second electrode layer. The solid electrolyte layer includes a first element. The first electrode layer includes a second element having a valence that is less likely to change than the first element.

### TECHNICAL FIELD

The present disclosure relates to an electrochemical cell, an electrochemical cell device, a module, and a module housing device.

### BACKGROUND OF INVENTION

In recent years, various fuel cell stack devices each including a plurality of fuel cells have been proposed as next-generation energy. A fuel cell is a type of electrochemical cell capable of obtaining electrical power by using a fuel gas such as a hydrogen-containing gas and an oxygen-containing gas such as air.

### CITATION LIST

### Patent Literature

Patent Document 1: JP 2018-152200 A

### SUMMARY

An electrochemical cell according to an aspect of an embodiment includes a first electrode layer, a second electrode layer, and a solid electrolyte layer. The solid electrolyte layer is located between the first electrode layer and the second electrode layer. The solid electrolyte layer includes a first element. The first electrode layer includes a second element having a valence that is less likely to change than the first element.

An electrochemical cell device of the present disclosure includes a cell stack including the electrochemical cell described above.

A module of the present disclosure includes the electrochemical cell device described above and a storage container configured to house the electrochemical cell device.

A module housing device of the present disclosure includes the module described above, an auxiliary device configured to operate the module, and an external case configured to house the module and the auxiliary device.

### BRIEF DESCRIPTION OF THE DRAWINGS

FIG. 1A is a horizontal cross-sectional view illustrating an example of an electrochemical cell according to a first embodiment.

FIG. 1B is a side view of an example of the electrochemical cell according to the first embodiment when viewed from the side of an air electrode.

FIG. 1C is a side view of an example of the electrochemical cell according to the first embodiment when viewed from the side of an interconnector.

FIG. 2A is a perspective view illustrating an example of an electrochemical cell device according to the first embodiment.

FIG. 2B is a cross-sectional view taken along line X-X illustrated in FIG. 2A.

FIG. 2C is a top view illustrating an example of the electrochemical cell device according to the first embodiment.

FIG. 3A is an enlarged cross-sectional view of a region R1 illustrated in FIG. 1A.

FIG. 3B is a cross-sectional view illustrating another example of the region R1 illustrated in FIG. 1A.

FIG. 4 is an exterior appearance perspective view illustrating an example of a module according to the first embodiment.

FIG. 5 is an exploded perspective view schematically illustrating an example of a module housing device according to the first embodiment.

FIG. 6A is a cross-sectional view illustrating an example of an electrochemical cell device according to a second embodiment.

FIG. 6B is a horizontal cross-sectional view illustrating an example of an electrochemical cell included in the electrochemical cell device according to the second embodiment.

FIG. 7 is an enlarged cross-sectional view of a region R2 illustrated in FIG. 6B.

FIG. 8 is a perspective view illustrating an example of an electrochemical cell according to a third embodiment.

FIG. 9 is a partial cross-sectional view of the electrochemical cell illustrated in FIG. 8.

FIG. 10 is an enlarged cross-sectional view of a region R3 illustrated in FIG. 9.

FIG. 11A is a horizontal cross-sectional view illustrating an example of an electrochemical cell according to a fourth embodiment.

FIG. 11B is a horizontal cross-sectional view illustrating another example of the electrochemical cell according to the fourth embodiment.

FIG. 11C is a horizontal cross-sectional view illustrating another example of the electrochemical cell according to the fourth embodiment.

FIG. 12 is an enlarged cross-sectional view of a region R4 illustrated in FIG. 11A.

### DESCRIPTION OF EMBODIMENTS

In the fuel cell stack device described above, power generation performance may deteriorate.

In this regard, it is expected to provide an electrochemical cell, an electrochemical cell device, a module, and a module housing device having performance less likely to deteriorate.

Embodiments of an electrochemical cell, an electrochemical cell device, a module, and a module housing device disclosed in the present application are described below in detail with reference to the accompanying drawings. Note that the disclosure is not limited by the following embodiments.

Note that the drawings are schematic and that the dimensional relationships between elements, the proportions of the elements, and the like may differ from the actual ones. There may be differences between the drawings in the dimensional relationships, proportions, and the like.

### First Embodiment

### Configuration of Electrochemical Cell

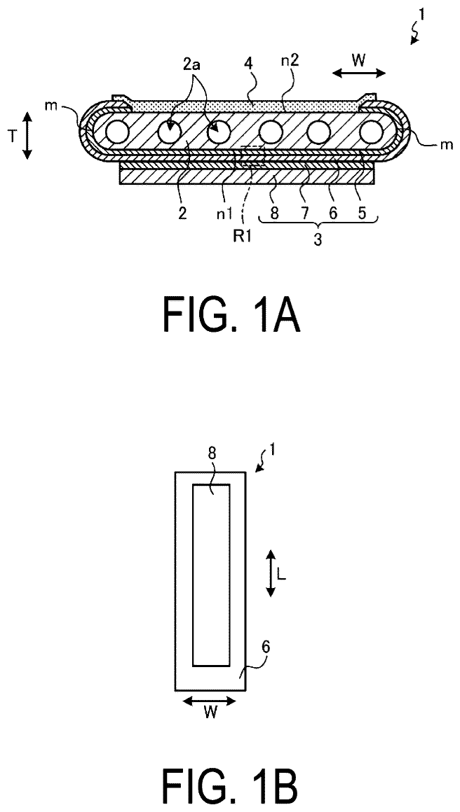

First, with reference to FIGS. 1A to 1C, an example of a solid oxide fuel cell is described as an electrochemical cell constituting an electrochemical cell device according to the first embodiment. The electrochemical cell device may include a cell stack including a plurality of electrochemical cells. The electrochemical cell device including the plurality of electrochemical cells is simply referred to as a cell stack device.

FIG. 1A is a horizontal cross-sectional view illustrating an example of the electrochemical cell according to the first embodiment. FIG. 1B is a side view of an example of the electrochemical cell according to the first embodiment when viewed from the side of an air electrode. FIG. 1C is a side view of an example of the electrochemical cell according to the first embodiment when viewed from the side of an interconnector. Note that FIGS. 1A to 1C are enlarged views each illustrating a part of a configuration of the electrochemical cell. The electrochemical cell may be simply referred to as a cell.

In the example illustrated in FIGS. 1A to 1C, a cell 1 is of a hollow flat plate type, and has an elongated plate shape. As illustrated in FIG. 1B, the overall shape of the cell 1 when viewed from the side may be, for example, a rectangle having a side length of 5 cm to 50 cm in a length direction L and a length of 1 cm to 10 cm in a width direction W orthogonal to the length direction L. The thickness in a thickness direction T of the entire cell 1 may be, for example, from 1 mm to 5 mm.

As illustrated in FIG. 1A, the cell 1 includes a support substrate 2 with electrical conductivity, an element portion 3, and an interconnector 4. The support substrate 2 has a pillar shape having a pair of a first surface n1 and a second surface n2 that face each other, and a pair of arc-shaped lateral surfaces m that connect the first surface n1 and the second surface n2.

The element portion 3 is provided on the first surface n1 of the support substrate 2. The element portion 3 includes a fuel electrode layer 5, a solid electrolyte layer 6, and an air electrode layer 8. In the example illustrated in FIG. 1A, the interconnector 4 is located on the second surface n2 of the cell 1. The cell 1 may include an intermediate layer 7 between the solid electrolyte layer 6 and the air electrode layer 8.

As illustrated in FIG. 1B, the air electrode layer 8 does not extend to a lower end of the cell 1. At the lower end portion of the cell 1, only the solid electrolyte layer 6 is exposed on a surface of the first surface n1. As illustrated in FIG. 1C, the interconnector 4 may extend to the lower end of the cell 1. At the lower end portion of the cell 1, the interconnector 4 and the solid electrolyte layer 6 are exposed on the surface. Note that, as illustrated in FIG. 1A, on the surface of the pair of the circular arc-shaped lateral surfaces m of the cell 1, the solid electrolyte layer 6 is exposed. The interconnector 4 may not extend to the lower end of the cell 1.

Each of the constituent members constituting the cell 1 is described below.

The support substrate 2 is provided therein with gas-flow passages 2a through which gas flows. The example of the support substrate 2 illustrated in FIG. 1A includes six gas-flow passages 2a. The support substrate 2 has gas permeability and allows a fuel gas flowing through the gas-flow passages 2a to pass through to the fuel electrode layer 5. The support substrate 2 may be electrically conductive. The support substrate 2 having electrical conductivity collects electricity generated in the element portion 3 to the interconnector 4.

The material of the support substrate 2 includes, for example, an iron group metal component and an inorganic oxide. For example, the iron group metal component may be Ni (nickel) and/or NiO. The inorganic oxide may be, for example, a specific rare earth element oxide. The rare earth element oxide may contain, for example, one or more rare earth elements selected from Sc, Y, La, Nd, Sm, Gd, Dy, and Yb.

As the fuel electrode layer 5, a porous electrically conductive ceramic, such as a ceramic containing an oxide having ion conductivity such as ZrO₂, in which a calcium oxide, a magnesium oxide, or a rare earth element oxide is in solid solution, and a metal having electron conductivity such as Ni, may be used. The rare earth element oxide may include, for example, Y and/or Sc. Hereinafter, ZrO₂ in which a calcium oxide, a magnesium oxide, or a rare earth element oxide is in solid solution may be referred to as stabilized zirconia. The stabilized zirconia may include partially stabilized zirconia. The electrically conductive ceramic may be, for example, a ceramic containing an electrolyte material to be described below and Ni and/or NiO. The fuel electrode layer 5 is an example of a first electrode layer.

The open porosity of the fuel electrode layer 5 may be, for example, 15% or more, and particularly may be in a range from 20% to 40%. The thickness of the fuel electrode layer 5 may be, for example, 1 μm to 30 μm. Details of the fuel electrode layer 5 are described below.

The solid electrolyte layer 6 is an electrolyte and delivers ions between the fuel electrode layer 5 and the air electrode layer 8. At the same time, the solid electrolyte layer 6 has gas blocking properties, and makes a leakage of the fuel gas and the oxygen-containing gas less likely to occur.

The solid electrolyte layer 6 has ion conductivity. The solid electrolyte layer 6 may contain Zr, for example. The material of the solid electrolyte layer 6 may be, for example, ZrO₂ in which 3 mole % to 15 mole % of rare earth element oxide is in solid solution. The rare earth element oxide may contain, for example, one or more rare earth elements selected from Ce, Pr, Nd, Sm, Eu, Tb, Tm, and Yb. The material of the solid electrolyte layer 6 may be, for example, stabilized zirconia containing Yb. The material of the solid electrolyte layer 6 may be, for example, a ceria-based material in which Pr, Nd, Sm, Eu, Tb, Tm, or Yb is in solid solution. Details of the solid electrolyte layer 6 are described below.

The air electrode layer 8 has gas permeability. The air electrode layer 8 is an example of a second electrode layer. The open porosity of the air electrode layer 8 may be, for example, in the range from 20% to 50%, particularly, from 30% to 50%.

The material of the air electrode layer 8 is not particularly limited as long as it is generally used for air electrodes. The material of the air electrode layer 8 may be, for example, an electrically conductive ceramic such as a so-called ABO₃-type perovskite oxide.

The material of the air electrode layer 8 may be, for example, a composite oxide in which strontium (Sr) and lanthanum (La) coexist in an A-site. Examples of such a composite oxide include LaₓSr₁₋ₓCo_{y}Fe_{1-y}O₃, LaₓSr₁₋ₓMnO₃, LaₓSr₁₋ₓFeO₃, and LaₓSr₁₋ₓCoO₃. Here, x is 0<x<1, and y is 0<y<1.

When the element portion 3 includes the intermediate layer 7, the intermediate layer 7 functions as a diffusion suppression layer. When an element such as strontium (Sr) contained in the air electrode layer 8 diffuses into the solid electrolyte layer 6, for example, a resistance layer such as SrZrO₃ is formed in such a solid electrolyte layer 6. The intermediate layer 7 makes it difficult to diffuse Sr, thereby making it difficult to form SrZrO₃ and other oxides having electrical insulation properties.

The material of the intermediate layer 7 is not particularly limited as long as it generally helps prevent diffusion of elements between the air electrode layer 8 and the solid electrolyte layer 6. The material of the intermediate layer 7 may contain, for example, cerium oxide (CeO₂) in which rare earth elements other than cerium (Ce) are in solid solution. As such rare earth elements, for example, gadolinium (Gd), samarium (Sm), or the like may be used.

The interconnector 4 is dense, and makes, less likely to occur, the leakage of the fuel gas flowing through the gas-flow passages 2a located inside the support substrate 2, and of the oxygen-containing gas flowing outside the support substrate 2. The interconnector 4 may have a relative density of 93% or more, particularly 95% or more.

As the material of the interconnector 4, a lanthanum chromite-based perovskite oxide (LaCrO₃-based oxide), a lanthanum strontium titanium-based perovskite oxide (LaSrTiO₃-based oxide), or the like may be used. These materials have electrical conductivity, and are less likely to be reduced and also less likely to be oxidized even when brought into contact with a fuel gas such as a hydrogen-containing gas and an oxygen-containing gas such as air. A metal or an alloy may be used as the material of the interconnector 4.

### Configuration of Electrochemical Cell Device

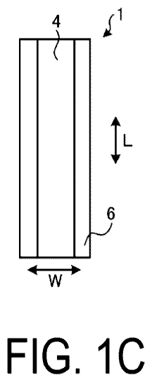

An electrochemical cell device according to the present embodiment using the electrochemical cell described above is described below with reference to FIGS. 2A to 2C. FIG. 2A is a perspective view illustrating an example of the electrochemical cell device according to the first embodiment. FIG. 2B is a cross-sectional view taken along line X-X illustrated in FIG. 2A. FIG. 2C is a top view illustrating an example of the electrochemical cell device according to the first embodiment.

As illustrated in FIG. 2A, a cell stack device 10 includes a cell stack 11 including a plurality of the cells 1 arrayed (layered) in the thickness direction T (see FIG. 1A) of each cell 1, and a fixing member 12.

The fixing member 12 includes a fixing material 13 and a support member 14. The support member 14 supports the cells 1. The fixing material 13 fixes the cells 1 to the support member 14. The support member 14 includes a support body 15 and a gas tank 16. The support body 15 and the gas tank 16, constituting the support member 14, are made of a metal and electrically conductive, for example.

As illustrated in FIG. 2B, the support body 15 includes an insertion hole 15a into which the lower end portions of the plurality of cells 1 are inserted. The lower end portions of the plurality of cells 1 and the inner wall of the insertion hole 15a are bonded with the fixing material 13.

The gas tank 16 includes an opening portion through which a reactive gas is supplied to the plurality of cells 1 via the insertion hole 15a, and a recessed groove 16a located on the periphery of the opening portion. The outer peripheral end portion of the support body 15 is bonded to the gas tank 16 by a bonding material 21 with which the recessed groove 16a of the gas tank 16 is filled.

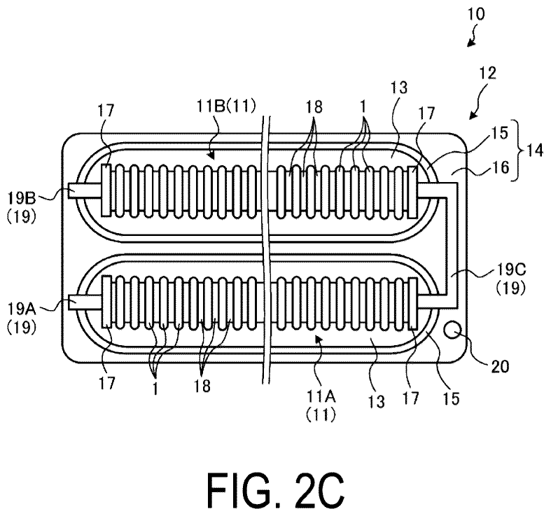

In the example illustrated in FIG. 2A, the fuel gas is stored in an internal space 22 (see FIG. 2B) formed by the support body 15 and the gas tank 16 constituting the support member 14. A gas circulation pipe 20 is connected to the gas tank 16. The fuel gas is supplied to the gas tank 16 through the gas circulation pipe 20 and is supplied from the gas tank 16 to the gas-flow passages 2a (see FIG. 1A) inside the cells 1. The fuel gas to be supplied to the gas tank 16 is generated in a reformer 102 (see FIG. 4) to be described below.

A hydrogen-rich fuel gas can be generated, for example, by steam-reforming a raw fuel. When the fuel gas is generated by steam-reforming, the fuel gas contains steam.

In the example illustrated in FIG. 2A, the cell stack device 10 includes two rows of the cell stacks 11, the two support bodies 15, and the gas tank 16. Each of the two rows of the cell stacks 11 includes the plurality of cells 1. Each of the cell stacks 11 is fixed to a corresponding one of the support bodies 15. An upper surface of the gas tank 16 includes two through holes. Each of the support bodies 15 is disposed in a corresponding one of the through holes. The internal space 22 is constituted by one gas tank 16 and two support bodies 15. Although the cell stack device 10 including the two rows of the cell stacks 11 is illustrated in FIG. 2A, the cell stack device may include one row of the cell stacks 11 or three or more rows of the cell stacks 11.

The insertion hole 15a has, for example, an oval shape in top view. The length of the insertion hole 15a in an arrangement direction of the cells 1, that is, the thickness direction T, may be longer than the distance between two end current collection members 17 located at both ends of the cell stack 11, for example. The width of the insertion hole 15a may be, for example, greater than the length of the cell 1 in the width direction W (see FIG. 1A).

As illustrated in FIG. 2B, bonding portions between the inner wall of the insertion hole 15a and the lower end portions of the cells 1 are filled with the fixing material 13, which is solidified. Thus, the inner wall of the insertion hole 15a and the lower end portions of the plurality of cells 1 are bonded and fixed, and the lower end portions of the cells 1 are bonded and fixed to each other. The gas-flow passages 2a of each of the cells 1 communicate, at the lower end portion thereof, with the internal space 22 of the support member 14.

The fixing material 13 and the bonding material 21 can be made of a material having a low electrical conductivity, such as glass. As the specific materials of the fixing material 13 and the bonding material 21, amorphous glass or the like may be used, and in particular, crystallized glass or the like may be used.

As the crystallized glass, for example, any one of SiO₂—CaO-based, MgO—B₂O₃-based, La₂O₃—B₂O₃—MgO-based, La₂O₃—B₂O₃—ZnO-based, and SiO₂—CaO—ZnO-based materials may be used, or in particular, an SiO₂—MgO-based material may be used.

As illustrated in FIG. 2B, an electrically conductive member 18 is interposed between cells 1 adjacent to each other among the plurality of cells 1. Each of the electrically conductive members 18 electrically connects in series the fuel electrode layer 5 of one of the adjacent ones of the cells 1 with the air electrode layer 8 of the other one of the adjacent ones of the cells 1. More specifically, the electrically conductive member 18 connects the interconnector 4 electrically connected to the fuel electrode layer 5 of the one of the adjacent ones of the cells 1 with the air electrode layer 8 of the other one of the adjacent ones of the cells 1. Note that, when the interconnector 4 is made of a metal or an alloy, the interconnector 4 and the electrically conductive member 18 may be integrated with each other, or the electrically conductive member 18 may also serve as the interconnector 4.

As illustrated in FIG. 2B, the end current collection members 17 are electrically connected to the cells 1 located at the outermost sides in the arrangement direction of the plurality of cells 1. The end current collection members 17 are each connected to an electrically conductive portion 19 protruding outward from the cell stack 11. The electrically conductive portion 19 collects electricity generated by the cells 1 and conducts the electricity to the outside. Note that in FIG. 2A, the end current collection members 17 are not illustrated.

As illustrated in FIG. 2C, in the cell stack device 10, two cell stacks 11A and 11B are connected in series and function as one battery. Therefore, the electrically conductive portion 19 of the cell stack device 10 is divided into a positive electrode terminal 19A, a negative electrode terminal 19B, and a connection terminal 19C.

The positive electrode terminal 19A functions as a positive electrode when the electrical power generated by the cell stack 11 is output to the outside, and is electrically connected to the end current collection member 17 on a positive electrode side in the cell stack 11A. The negative electrode terminal 19B functions as a negative electrode when the electrical power generated by the cell stack 11 is output to the outside, and is electrically connected to the end current collection member 17 on a negative electrode side in the cell stack 11B.

The connection terminal 19C electrically connects the end current collection member 17 on the negative electrode side in the cell stack 11A and the end current collection member 17 on the positive electrode side in the cell stack 11B.

### Details of Element Portion

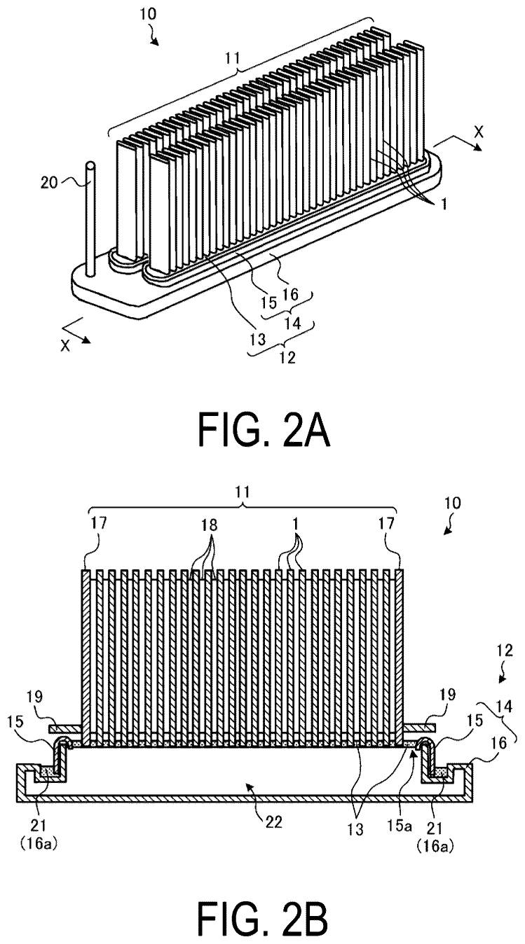

Subsequently, details of the fuel electrode layer 5 and the solid electrolyte layer 6 included in the element portion 3 according to the first embodiment are described with reference to FIGS. 3A and 3B. FIG. 3A is an enlarged cross-sectional view of a region R1 illustrated in FIG. 1A.

As illustrated in FIG. 3A, the solid electrolyte layer 6 includes a first element 6a. The first element 6 a may be, for example, a lanthanoid element having electrons in a 4f orbital. The first element 6a may be, for example, one or more elements selected from Pr, Nd, Sm, Eu, Tb, Tm, and Yb.

The fuel electrode layer 5 includes a second element 5a. The valence of the second element 5a is less likely to change than the valence of the first element 6a. Such a second element 5a may be, for example, one or more elements selected from Y, Sc, Mg, and Ca.

Here, “the valence is less likely to change” means that the valence is less likely to fluctuate, that is, the valence in a solid is stable at a certain value. For example, in a solid, the valences of Y and Sc are stable at 3+, and the valences of Mg and Ca are stable at 2+. In this way, the fuel electrode layer 5 includes the second element 5a whose valence is less likely to change than the first element 6a, and thus the ion conductivity is less likely to decrease as compared with the case where the fuel electrode layer 5 in a reducing atmosphere includes the first element 6a. Therefore, the conductivity of the fuel electrode layer 5 is less likely to decrease, so that the cell 1 having the power generation performance less likely to deteriorate is obtained.

The solid electrolyte layer 6 includes an electrolyte material having ion conductivity. The solid electrolytic layer 6 may include, as an electrolytic material, a metal oxide containing the first element 6a. The first element 6a may be in solid solution in the electrolytic material included in the solid electrolyte layer 6. The electrolyte material of the solid electrolyte layer 6 may contain Zr or Ce. The electrolyte material of the solid electrolyte layer 6 may be an oxide containing Zr or Ce. The lanthanoid element having electrons in the 4f orbital have a small ionic radius. In the electrolytic material in which the element having a small ionic radius is solid-dissolved as the first element 6a, an oxygen vacancy is likely to occur. The electrolyte material in which an oxygen vacancy is likely to occur tends to exhibit high ion conductivity. On the other hand, the valence of the lanthanoid element having electrons in the 4f orbital is likely to change. In other words, such an element tends to fluctuate between different valence states in the solid, for example, between 2+ and 3+ valences. Such an element is easily reduced in a reducing atmosphere.

The fuel electrode layer 5 includes an electrolyte material having ion conductivity. The fuel electrode layer 5 may include, as an electrolytic material, a metal oxide containing the second element 5a. The second element 5a may be in solid solution in the electrolytic material of the fuel electrode layer 5. The electrolyte material of the fuel electrode layer 5 may contain Zr. The electrolyte material of the fuel electrode layer 5 may be an oxide containing Zr. The electrolyte material of the fuel electrode layer 5 may be the same as or different from the electrolyte material of the solid electrolyte layer 6. The second element 5a is less likely to be reduced than the first element 6a in a reducing atmosphere. Therefore, the electrolytic material in which the second element 5a is solid-dissolved is less likely to decrease in ion conductivity even under a reducing atmosphere than the electrolytic material in which the first element 6a is solid-dissolved.

The fuel electrode layer 5 may further include metal-containing catalytic particles 5b. The catalytic particles 5b may be, for example, Ni and/or NiO.

FIG. 3B is a cross-sectional view illustrating another example of the region R1 illustrated in FIG. 1A. As illustrated in FIG. 3B, the fuel electrode layer 5 may further include the first element 6a. This improves the bonding strength between the solid electrolytic layer 6 including the first element 6a and the fuel electrode layer 5.

The solid electrolytic layer 6 may further include the second element 5a. This improves the bonding strength between the fuel electrode layer 5 including the second element 5a and the solid electrolytic layer 6.

In addition, when the fuel electrode layer 5 includes the first element 6a, the content of the first element 6a in the solid electrolytic layer 6 may be larger than that in the fuel electrode layer 5. Thus, even when the fuel electrode layer 5 has the first element 6a, the power generation performance is less likely to deteriorate. Note that, when the fuel electrode layer 5 and/or the solid electrolytic layer 6 include a plurality of first elements 6a, the content of the first element 6a refers to the total content of the plurality of first elements 6a. The content of the first element 6a is a molar ratio (mole %) of the first element 6a in terms of oxide to the total of the elements included in the fuel electrode layer 5 and the solid electrolytic layer 6 in terms of oxide at a predetermined portion. The content of the first element 6a in each of the fuel electrode layer 5 and the solid electrolytic layer 6 can be confirmed by, for example, elemental analysis using EPMA. Specifically, a cross-sectional image including the fuel electrode layer 5 and the solid electrolyte layer 6 is captured. In a region of the captured cross-sectional image, the elements included in the fuel electrode layer 5 and the solid electrolyte layer 6 are analyzed. From the obtained elemental analysis results, the mean values of the contents (molar ratios) of the first element 6a in the respective portions may be calculated and compared. The elements included in the fuel electrode layer 5 and the solid electrolyte layer 6 are elements detected from the electrolyte materials included in predetermined portions of the fuel electrode layer 5 and the solid electrolyte layer 6. In other words, when comparing the contents of the first element 6a in the respective portions, the content of the first element 6a in the remaining elements excluding the catalyst particles 5b included in the fuel electrode layer 5 may be compared.

When the solid electrolytic layer 6 includes the second element 5a, the solid electrolytic layer 6 may include the second element 5a in the vicinity of a surface 61 (first surface) facing the fuel electrode layer 5. This improves the bonding strength between the fuel electrode layer 5 and the solid electrolytic layer 6. Here, “the vicinity of the surface 61” refers to a portion closer to the surface 61 than to a surface 62 when the surface 61 of the solid electrolyte layer 6 facing the fuel electrode layer 5 and the surface 62 of the solid electrolyte layer 6 located on the opposite side of the surface 61 are defined.

In addition, when the fuel electrode layer 5 includes the first element 6a, the fuel electrode layer 5 may include the first element 6 a in the vicinity of a surface 51 (second surface) facing the solid electrolytic layer 6. This improves the bonding strength between the fuel electrode layer 5 and the solid electrolytic layer 6. Here, “the vicinity of the surface 51” refers to a portion closer to the surface 51 than to a surface 52 when the surface 51 of the fuel electrode layer 5 facing the solid electrolyte layer 6 and the surface 52 of the fuel electrode layer 5 located on the opposite side of the surface 51 are defined.

In addition, when the fuel electrode layer 5 includes the first element 6a, the fuel electrode layer 5 may include the first element 6 a only in the vicinity of the surface 51 (second surface) facing the solid electrolytic layer 6. Since the conductivity of the fuel electrode layer 5 is less likely to decrease, the cell 1 having the power generation performance less likely to deteriorate is obtained, and the bonding strength between the fuel electrode layer 5 and the solid electrolyte layer 6 is improved.

### Module

A module according to the present embodiment using the above-described electrochemical cell device is described below with reference to FIG. 4. FIG. 4 is an exterior appearance perspective view illustrating an example of the module according to the first embodiment. FIG. 4 illustrates a state in which the front and rear surfaces, which constitute a part of a storage container 101, are removed and the cell stack device 10 of the fuel cell housed inside is taken out rearward.

As illustrated in FIG. 4, a module 100 includes the storage container 101, and the cell stack device 10 housed in the storage container 101. The reformer 102 is disposed above the cell stack device 10.

The reformer 102 generates a fuel gas by reforming a raw fuel such as natural gas and kerosene and supplies the fuel gas to the cell 1. The raw fuel is supplied to the reformer 102 through a raw fuel supply pipe 103. Note that the reformer 102 may include a vaporizing unit 102a for vaporizing water and a reforming unit 102b. The reforming unit 102b includes a reforming catalyst (not illustrated) to reform the raw fuel into a fuel gas. The reformer 102 can perform steam reforming that is a highly efficient reformation reaction.

The fuel gas generated by the reformer 102 is supplied to the gas-flow passages 2a of the cell 1 (see FIG. 1A) through the gas circulation pipe 20, the gas tank 16, and the support member 14.

In the module 100 having the configuration mentioned above, the temperature in the module 100 during normal power generation is from about 500 °C to 1000 °C due to combustion of gas and power generation by the cell 1.

As described above, the module 100 is configured by housing the cell stack device 10 having the power generation performance less likely to deteriorate, so that the module 100 having the power generation performance less likely to deteriorate can be obtained.

### Module Housing Device

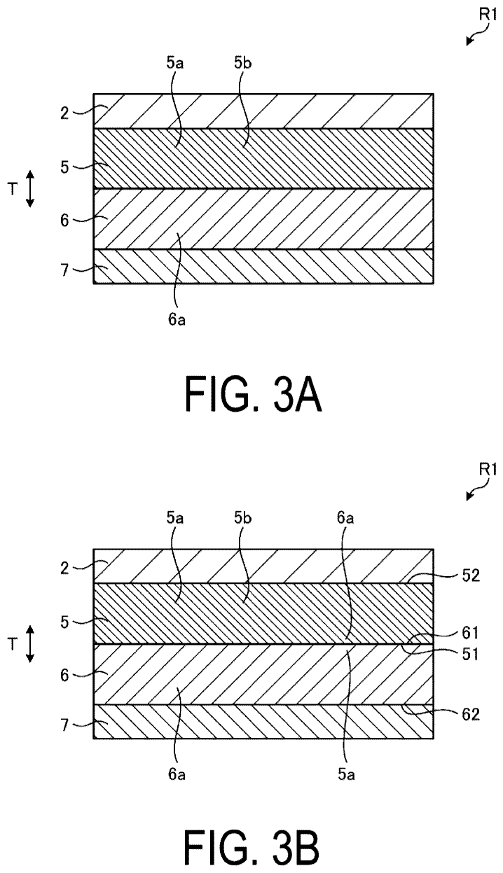

FIG. 5 is an exploded perspective view schematically illustrating an example of a module housing device according to the first embodiment. A module housing device 110 according to the present embodiment includes an external case 111, the module 100 illustrated in FIG. 4, and an auxiliary device (not illustrated). The auxiliary device operates the module 100. The module 100 and the auxiliary device are housed in the external case 111. Note that, in FIG. 5, a part of the configuration is not illustrated.

The external case 111 of the module housing device 110 illustrated in FIG. 5 includes a support 112 and an external plate 113. A dividing plate 114 vertically partitions the interior of the external case 111. The space above the dividing plate 114 in the external case 111 is a module housing chamber 115 for housing the module 100. The space below the dividing plate 114 in the external case 111 is an auxiliary device housing chamber 116 for housing the auxiliary device configured to operate the module 100. Note that, in FIG. 5, the auxiliary device housed in the auxiliary device housing chamber 116 is not illustrated.

The dividing plate 114 includes an air circulation hole 117 for causing air in the auxiliary device housing chamber 116 to flow to the module housing chamber 115 side. The external plate 113 constituting the module housing chamber 115 has an exhaust hole 118 for discharging air inside the module housing chamber 115.

As described above, in the module housing device 110, the module housing chamber 115 includes the module 100 having the power generation performance less likely to deteriorate, so that the module housing device 110 having the power generation performance less likely to deteriorate can be obtained.

Note that, in the embodiment described above, the case in which the support substrate having the hollow flat plate shape is used has been exemplified, but the embodiment can also be applied to a cell stack device using a cylindrical support substrate.

### Second Embodiment

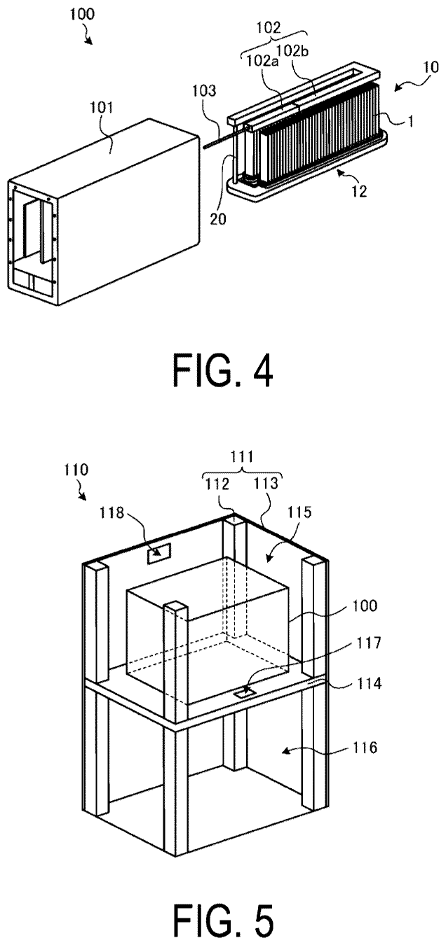

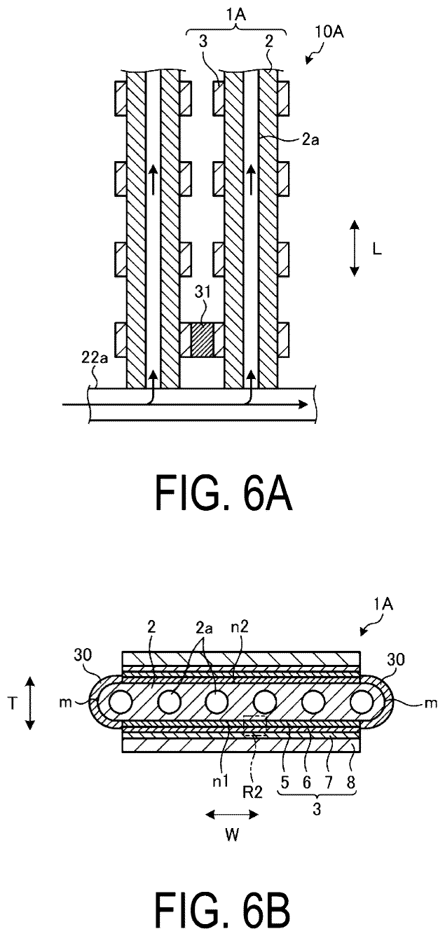

Subsequently, an electrochemical cell and an electrochemical cell device according to a second embodiment are described with reference to FIGS. 6A, 6B, and 7.

In the embodiment described above, a so-called “vertically striped type” electrochemical cell device, in which only one element portion including the fuel electrode layer, the solid electrolyte layer, and the air electrode layer is provided on the surface of the support substrate, is exemplified. However, the present disclosure can be applied to a horizontally striped type electrochemical cell device with an array of so-called “horizontally striped type” electrochemical cells, in which a plurality of element portions are provided on the surface of the support substrate at mutually separated locations and adjacent element portions are electrically connected to each other.

FIG. 6A is a cross-sectional view illustrating an example of the electrochemical cell device according to the second embodiment. FIG. 6B is a horizontal cross-sectional view illustrating an example of an electrochemical cell included in the electrochemical cell device according to the second embodiment.

As illustrated in FIG. 6A, a cell stack device 10A according to the present embodiment includes a plurality of cells 1A extending in the length direction L from a pipe 22a configured to distribute a fuel gas. Each of the cells 1A includes a plurality of the element portions 3 on the support substrate 2. The gas-flow passage 2a, through which a fuel gas from the pipe 22a flows, is provided inside the support substrate 2.

The cells 1A are electrically connected to each other via connecting members 31. Each of the connecting members 31 is located between the element portions 3 each included in a corresponding one of the cells 1A and connects adjacent ones of the cells 1A to each other. Specifically, the connecting member 31 electrically connects the air electrode layer 8 of the element portion 3 of one of the adjacent ones of the cells 1A to the fuel electrode layer 5 of the element portion 3 of the other one of the adjacent ones of the cells 1A.

As illustrated in FIG. 6B, the cell 1A includes the support substrate 2, a pair of element portions 3, and a sealing portion 30. The support substrate 2 has a pillar shape having a first surface n1 and a second surface n2 that are a pair of flat surfaces facing each other, and a pair of circular arc-shaped lateral surfaces m that connect the first surface n1 and the second surface n2.

The pair of element portions 3 are located on the first surface n1 and the second surface n2 of the support substrate 2 so as to face each other. The sealing portion 30 is located to cover the lateral surfaces m of the support substrate 2.

FIG. 7 is an enlarged cross-sectional view of a region R2 illustrated in FIG. 6B. The solid electrolyte layer 6 includes the first element 6a. The fuel electrode layer 5 includes the second element 5a whose valence is less likely to change than the first element 6a. The fuel electrode layer 5 may further include metal-containing catalytic particles 5b.

In this way, the fuel electrode layer 5 includes the second element 5a whose valence is less likely to change than the first element 6a, and thus the ion conductivity is less likely to decrease as compared with the case where the fuel electrode layer 5 in a reducing atmosphere includes the first element 6a. Therefore, the conductivity of the fuel electrode layer 5 is less likely to decrease, so that the cell 1A having the power generation performance less likely to deteriorate is obtained.

### Third Embodiment

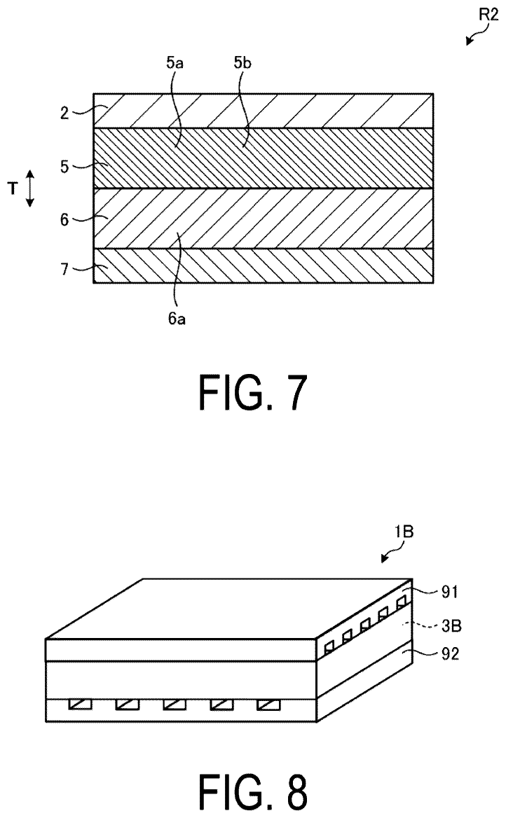

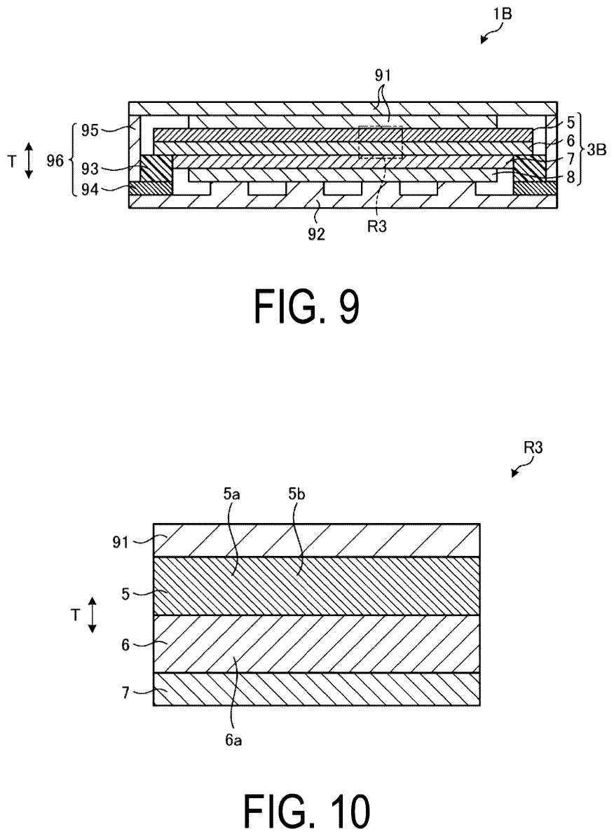

FIG. 8 is a perspective view illustrating an example of an electrochemical cell according to a third embodiment. FIG. 9 is a partial cross-sectional view of the electrochemical cell illustrated in FIG. 8.

As illustrated in FIGS. 8 and 9, cells 1B each include an element portion 3B in which the fuel electrode layer 5, the solid electrolyte layer 6, the intermediate layer 7, and the air electrode layer 8 are layered. The element portion 3B is a site in which the solid electrolyte layer 6 is sandwiched between the fuel electrode layer 5 and the air electrode layer 8. In an electrochemical cell device in which a plurality of flat plate cells are layered, for example, a plurality of cells 1B are electrically connected by electrically conductive members 91 and 92 that are metal layers adjacent to each other. The electrically conductive members 91 and 92 electrically connect adjacent ones of the cells 1B to each other, and each include gas-flow passages for supplying gas to the fuel electrode layer 5 or the air electrode layer 8.

As illustrated in FIG. 9, the cell 1B includes a sealing material for hermetically sealing the flow passage of a fuel gas and the flow passage of an oxygen-containing gas in the flat plate cell stack. The sealing material is a fixing member 96 of the cell 1B, and includes a bonding material 93 and support members 94 and 95 constituting a frame. The bonding material 93 may be a glass or may be a metal material such as silver solder.

The support member 94 may be a so-called separator that separates the flow passage of the fuel gas and the flow passage of the oxygen-containing gas. The material of the support members 94 and 95 may be, for example, an electrically conductive metal, or may be an insulating ceramic. One or both of the support members 94 and 95 may be an insulating material. When the support member 94 is a metal, the support member 94 may be integrated with the electrically conductive member 92. When the support member 95 is a metal, the support member 95 may be integrated with the electrically conductive member 91.

One of the support members 94 and 95 has insulation properties and electrically insulates the two electrically conductive members 91 and 92, which sandwich the flat plate cell, from each other.

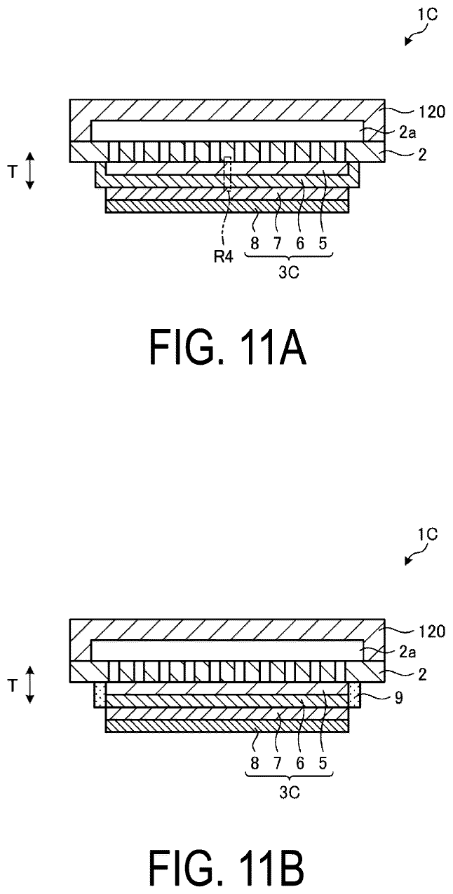

FIG. 10 is an enlarged cross-sectional view of a region R3 illustrated in FIG. 9. The solid electrolyte layer 6 includes the first element 6a. The fuel electrode layer 5 includes the second element 5a whose valence is less likely to change than the first element 6a. The fuel electrode layer 5 may further include metal-containing catalytic particles 5b.

In this way, the fuel electrode layer 5 includes the second element 5a whose valence is less likely to change than the first element 6a, and thus the ion conductivity is less likely to decrease as compared with the case where the fuel electrode layer 5 in a reducing atmosphere includes the first element 6a. Therefore, the conductivity of the fuel electrode layer 5 is less likely to decrease, so that the cell 1B having the power generation performance less likely to deteriorate is obtained.

### Fourth Embodiment

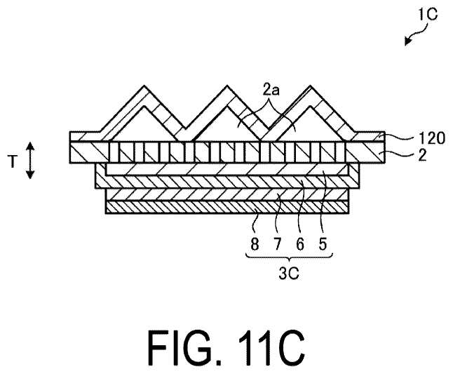

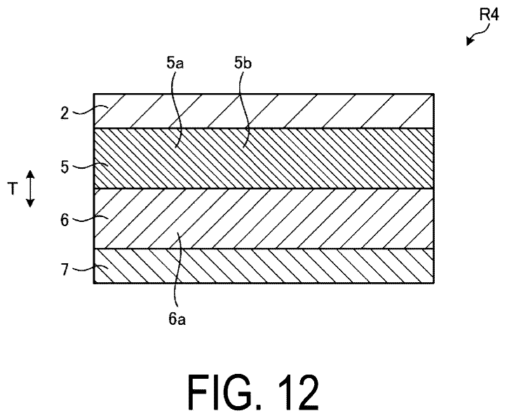

FIG. 11A is a horizontal cross-sectional view illustrating an example of an electrochemical cell according to a fourth embodiment. FIGS. 11B and 11C are horizontal cross-sectional views illustrating other examples of the electrochemical cell according to the fourth embodiment. FIG. 12 is an enlarged view of a region R4 illustrated in FIG. 11A. Note that FIG. 12 can also be applied to the examples of FIGS. 11B and 11C.

As illustrated in FIGS. 11A to 11C, cells 1C each include an element portion 3C in which the fuel electrode layer 5, the solid electrolyte layer 6, the intermediate layer 7, and the air electrode layer 8 are layered, and the support substrate 2. The support substrate 2 includes through holes or fine holes at a portion in contact with the element portion 3C, and includes a member 120 located outside the gas-flow passage 2a. The support substrate 2 allows gas to flow between the gas-flow passage 2a and the element portion 3C. The support substrate 2 may be made of, for example, one or more metal plates. A material of the metal plate may contain chromium. The metal plate may include an electrically conductive coating layer. The support substrate 2 electrically connects adjacent ones of the cells 1C to each other. The element portion 3C may be directly formed on the support substrate 2 or may be bonded to the support substrate 2 with a bonding material.

In the example illustrated in FIG. 11A, the lateral surface of the fuel electrode layer 5 is covered with the solid electrolyte layer 6 to hermetically seal the gas-flow passage 2a through which a fuel gas flows. As illustrated in FIG. 11B, the lateral surface of the fuel electrode layer 5 may be covered and sealed with a sealing material 9 made of dense glass or ceramic. The sealing material 9 covering the lateral surface of the fuel electrode layer 5 may have electrical insulation properties.

The gas-flow passage 2a of the support substrate 2 may be made of a member 120 having unevenness as illustrated in FIG. 11C.

FIG. 12 is an enlarged cross-sectional view of the region R4 illustrated in FIG. 11A. The solid electrolyte layer 6 includes the first element 6a. The fuel electrode layer 5 includes the second element 5a whose valence is less likely to change than the first element 6a. The fuel electrode layer 5 may further include metal-containing catalytic particles 5b.

In this way, the fuel electrode layer 5 includes the second element 5a whose valence is less likely to change than the first element 6a, and thus the ion conductivity is less likely to decrease as compared with the case where the fuel electrode layer 5 in a reducing atmosphere includes the first element 6a. Therefore, the conductivity of the fuel electrode layer 5 is less likely to decrease, so that the cell 1C having the power generation performance less likely to deteriorate is obtained.

### Other Embodiments

Subsequently, an electrochemical cell device according to other embodiments is described.

In the above embodiments, a fuel cell, a fuel cell stack device, a fuel cell module, and a fuel cell device are illustrated as examples of the “electrochemical cell”, the “electrochemical cell device”, the “module”, and the “module housing device”, respectively, but in other examples, they may be provided as an electrolyte cell, an electrolyte cell stack device, an electrolyte module, and an electrolyte device. The electrolytic cell includes a first electrode layer and a second electrode layer, and decomposes water vapor into hydrogen and oxygen or decomposes carbon dioxide into carbon monoxide and oxygen by supplying electric power. Although an oxide ion conductor or a hydrogen ion conductor is shown as an example of the electrolyte material of the electrochemical cell in the above embodiment, the electrolyte material may be a hydroxide ion conductor. Such an electrolytic cell, an electrolytic cell stack device, an electrolytic module, and an electrolytic device can have an improved electrolytic performance.

While the present disclosure has been described in detail, the present disclosure is not limited to the aforementioned embodiments, and various changes, improvements, and the like can be made without departing from the gist of the present disclosure. For example, instead of the regions R2 to R4 illustrated in FIGS. 7, 10, and 12, a mode corresponding to the region R1 illustrated in FIG. 3B may be adopted.

In an embodiment, (1) an electrochemical cell includes a first electrode layer, a second electrode layer, and
a solid electrolyte layer located between the first electrode layer and the second electrode layer,
wherein the solid electrolyte layer includes a first element, and
the first electrode layer includes a second element having a valence that is less likely to change than the first element.
(2) In the electrochemical cell of (1) above, the first electrode layer may include the first element, and
content of the first element in the solid electrolyte layer may be larger than a content of the first element in the first electrode layer.
(3) In the electrochemical cell of (1) or (2) above, the first electrode layer may further include metal-containing catalyst particles.
(4) In the electrochemical cell of any one of (1) to (3) above, the first electrode layer and the solid electrolyte layer may each include an electrolyte material having ion conductivity, and
the first element and the second element may be in solid solution in the electrolyte material.
(5) In the electrochemical cell of (4) above, the electrolyte material may contain Zr or Ce.
(6) In the electrochemical cell of any one of (1) to (5) above, the first element may be one or more elements selected from Pr, Nd, Sm, Eu, Tb, Tm, and Yb.
(7) In the electrochemical cell of any one of (1) to (6) above, the second element may be one or more elements selected from Y, Sc, Mg, and Ca.
(8) In the electrochemical cell of any one of (1) to (7) above, the solid electrolyte layer may include the second element in a vicinity of a first surface facing the first electrode layer.
(9) In the electrochemical cell of any one of (1) to (8) above, the first electrode layer may include the first element in a vicinity of a second surface facing the solid electrolyte layer.
(10) In the electrochemical cell of (9) above, the first electrode layer may include the first element only in the vicinity of the second surface.

In an embodiment, (11) an electrochemical cell device includes a cell stack comprising the electrochemical cell of any one of (1) to (10) above.

In an embodiment, (12) a module includes the electrochemical cell device of (11) above, and
a storage container configured to house the electrochemical cell device.

In an embodiment, (13) a module housing device includes the module of (12) above;
an auxiliary device configured to operate the module; and
an external case configured to house the module and the auxiliary device.

Note that the embodiments disclosed herein are exemplary in all respects and not restrictive. The aforementioned embodiments can be embodied in a variety of forms. The aforementioned embodiments may be omitted, replaced, or changed in various forms without departing from the scope of the appended claims and the purpose thereof.

### REFERENCE SIGNS

1 Cell
2 Support substrate
5 Fuel electrode layer
5a Second element
6 Solid electrolyte layer
6a First element
7 Intermediate layer
8 Air electrode layer
10 Cell stack device
11 Cell stack
12 Fixing member
13 Fixing material
14 Support member
15 Support body
16 Gas tank
17 End current collection member
18 Electrically conductive member
100 Module
110 Module housing device

1. An electrochemical cell comprising:
a first electrode layer;
a second electrode layer; and
a solid electrolyte layer located between the first electrode layer and the second electrode layer,
wherein the solid electrolyte layer comprises a first element, and
the first electrode layer comprises a second element having a valence that is less likely to change than the first element.

2. The electrochemical cell according to claim 1, wherein
the first electrode layer comprises the first element, and
a content of the first element in the solid electrolyte layer is larger than a content of the first element in the first electrode layer.

3. The electrochemical cell according to claim 1, wherein
the first electrode layer further comprises metal-containing catalyst particles.

4. The electrochemical cell according to claim 1, wherein
the first electrode layer and the solid electrolyte layer each comprise an electrolyte material having ion conductivity, and
the first element and the second element are in solid solution in the electrolyte material.

5. The electrochemical cell according to claim 4, wherein
the electrolyte material contains Zr or Ce.

6. The electrochemical cell according to claim 1, wherein
the first element is one or more elements selected from Pr, Nd, Sm, Eu, Tb, Tm, and Yb.

7. The electrochemical cell according to claim 1, wherein
the second element is one or more elements selected from Y, Sc, Mg, and Ca.

8. The electrochemical cell according to claim 1, wherein
the solid electrolyte layer comprises the second element in a vicinity of a first surface facing the first electrode layer.

9. The electrochemical cell according to claim 1, wherein
the first electrode layer comprises the first element in a vicinity of a second surface facing the solid electrolyte layer.

10. The electrochemical cell according to claim 9, wherein
the first electrode layer comprises the first element only in the vicinity of the second surface.

11. An electrochemical cell device comprising:
a cell stack comprising the electrochemical cell according to claim 1.

12. A module comprising:
the electrochemical cell device according to claim 11; and
a storage container configured to house the electrochemical cell device.

13. A module housing device comprising:
the module according to claim 12;
an auxiliary device configured to operate the module; and
an external case configured to house the module and the auxiliary device.
